(19) United States
(12) Patent Application Publication
(10) Pub. No.: US 2024/0154225 A1
(43) Pub. Date: May 9, 2024

(54) MEMBER CONNECTING STRUCTURE AND BATTERY CASE

(71) Applicant: TOYOTA JIDOSHA KABUSHIKI KAISHA, Toyota-shi (JP)

(72) Inventor: Katsunori HIGASHIHARA, Toyota-shi (JP)

(73) Assignee: TOYOTA JIDOSHA KABUSHIKI KAISHA, Toyota-shi (JP)

(21) Appl. No.: 18/382,601

(22) Filed: Oct. 23, 2023

(30) Foreign Application Priority Data
Nov. 9, 2022 (JP) 2022-179840

(51) Int. Cl. H01M 50/209; H01M 50/242

(52) U.S. Cl. CPC H01M 50/209; H01M 50/242

(57) ABSTRACT

The first end of the first longitudinal member and the second end of the second longitudinal member are connected at an angle. The first longitudinal member is provided with a first partition plate that partitions the inner space in the width direction in a closed cross section, and the first end portion is provided with a notch portion in which a distal end portion is cut out in the width direction from an outer side surface of the left side plate to a position in front of the first partition plate. The second end portion is combined with the notch portion such that the distal end surface abuts against the first partition plate of the notch portion and the outer side surface of the rear side plate abuts against the longitudinal end surface of the notch portion, and is welded to the first end portion.

### CROSS REFERENCE TO RELATED APPLICATION

This application claims priority to Japanese Patent Application No. 2022-179840 filed on Nov. 9, 2022, which is incorporated herein by reference in its entirety including the specification, claims, drawings, and abstract.

### TECHNICAL FIELD

The present disclosure relates to a connecting structure for connecting end portions of longitudinal members of two closed cross-sectional structures, and a battery case in which longitudinal members are connected in a rectangular frame shape by the connecting structure.

### BACKGROUND

A battery case that houses a battery that supplies electric power to a motor of a vehicle is required to protect a battery housed inside at the time of collision in various directions. Further, the battery case is required to suppress the intrusion of water from the outside.

Therefore, a battery tray using a metal outer frame has been proposed (See, e.g., JP2011-255705A, JP2021-516187A.). The outer frame of the battery tray described in JP2011-255705A, JP2021-516187A is formed by connecting aluminum extrusion members each having a rectangular closed cross section in a rectangular frame shape.

### SUMMARY

In the battery tray described in JP2011-255705A, an end surface of one aluminum extruding member abuts against a side surface of the other extruding member, and the aluminum extruding member and the other extruding member are connected by welding. For this reason, when a collision occurs in a direction in which a shearing force is applied to the weld portion, the load transmission may not be sufficient, and the battery disposed inside the tray may not be sufficiently protected.

In the battery case described in JP2021-516187A, the rib plate provided inside the member extending in the long-side direction and the member extending in the short-side direction cannot be sufficiently connected, and the internal battery cannot be sufficiently protected at the time of collision in various directions.

On the other hand, in order to reliably transmit a collision load upon collision from various directions, it is conceivable that the end portion of the aluminum extrusion member has a complicated shape. However, if the structure of the connecting portion is complicated, cutting and welding may be difficult.

Accordingly, it is an object of the present disclosure to reliably transmit a collision load at the time of collision from various directions with a simple structure.

A member connecting structure of the present disclosure is a member connecting structure for connecting a first end portion of a first longitudinal member and a second end portion of a second longitudinal member at an angle; wherein the first longitudinal member has a closed cross section and includes a first partition plate partitioning an inner space in a width direction, the first end portion includes a notch portion in which a distal end portion is cut out in a width direction from a first outer side surface up to the first partition plate, the second end portion is combined with the notch portion such that a distal end surface of the second end portion abuts against the first partition plate of the notch portion and a second outer side surface of the second end portion abuts against a longitudinal end surface of the first longitudinal member at the notch portion, and the second end portion is welded to the first end portion.

With this configuration, the load applied in the longitudinal direction of the second longitudinal member is transmitted from the distal end surface of the second longitudinal member to the first partition plate of the first longitudinal member. The load applied in the longitudinal direction of the first longitudinal member is transmitted from the longitudinal end surface of the notch of the first longitudinal member to the second outer surface of the second longitudinal member. Therefore, the member connecting structure of the present disclosure can reliably transmit a collision load when a collision occurs from various directions.

In the member connecting structure of the present disclosure, the second longitudinal member has a closed cross section and includes a second partition plate partitioning an inner space in a width direction, the length of the notch portion in a longitudinal direction of the first longitudinal member is the same as the length in the width direction between the second outer side surface and the second partition plate of the second longitudinal member, the second end portion is combined with the notch portion such that a part of the distal end surface abuts against the first partition plate of the notch portion, and is welded to the first end portion.

With this configuration, the collision load can be transmitted between the first partition plate of the first longitudinal member and the second partition plate of the second longitudinal member with a simple configuration. Therefore, the collision load can be transmitted more reliably at the time of collision from various directions.

In the member connecting structure of the present disclosure, a first plate end portion of the first partition plate may be welded and connected to a second plate end portion of the second partition plate.

With this structure, the collision load can be transmitted more reliably during collision from various directions.

A battery case of the present disclosure is a battery case in which two first longitudinal members and two second longitudinal members are connected to each other in a rectangular frame shape, wherein each of the first longitudinal members and each of the second longitudinal members are connected to each other by the member connecting structure described above.

This makes it possible to provide a battery case that is resistant to collisions from various directions.

The present disclosure can reliably transmit a collision load during collision from various directions with a simple structure.

### BRIEF DESCRIPTION OF DRAWINGS

Embodiment(s) of the present disclosure will be described based on the following figures, wherein:

FIG. 1 is a perspective view showing a member connecting structure according to an embodiment;

FIG. 2 is a perspective view of a first end of a first longitudinal member, a perspective view of a second end of a second longitudinal member, and a perspective view of a combination of a second longitudinal member and a notch of the first longitudinal member;

FIG. 3 is a plan view showing a member connecting structure of the embodiment;

FIG. 4 is a plan view showing a battery case to which the member connecting structure of the embodiment is applied;

FIG. 5 is a plan view showing a member connecting structure according to another embodiment.

### DESCRIPTION OF EMBODIMENTS

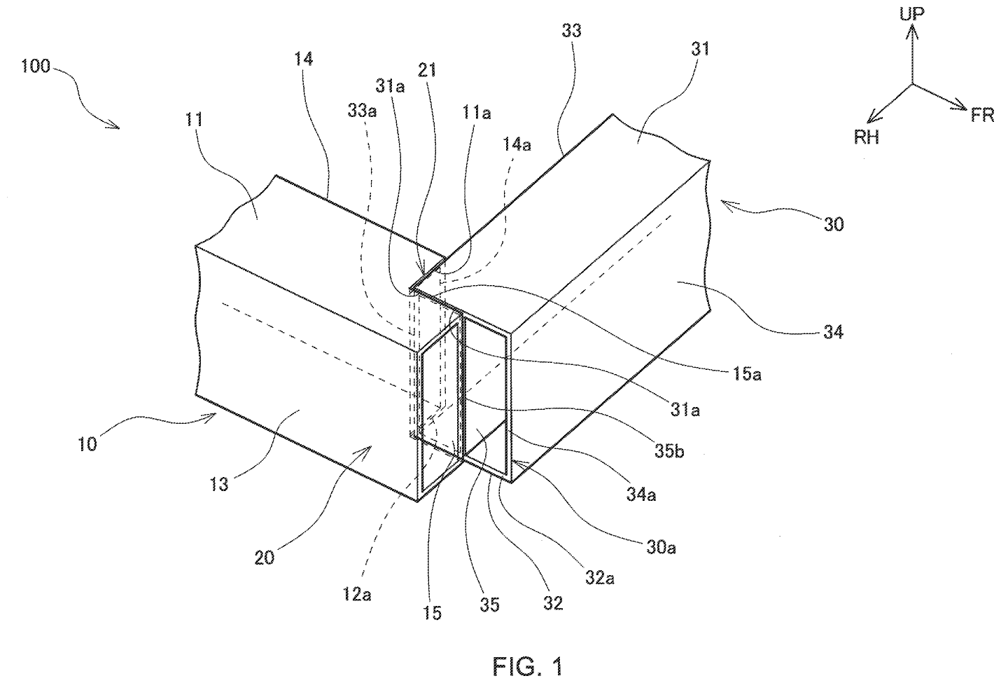

Hereinafter, a member connecting structure 100 according to an embodiment of the present disclosure will be described with reference to the drawings. As shown in FIG. 1, the member connecting structure 100 connects the first end portion 20 of the first longitudinal member 10 and the second end portion 30a of the second longitudinal member 30 at an angle of 90 degrees. Reference numerals FR, RH, and UP in the drawings indicate the front direction, the right direction, and the upper direction of the member connecting structure 100, and the opposite directions to reference numerals FR, RH, and UP indicate the rear direction, the left direction, and the lower direction, respectively.

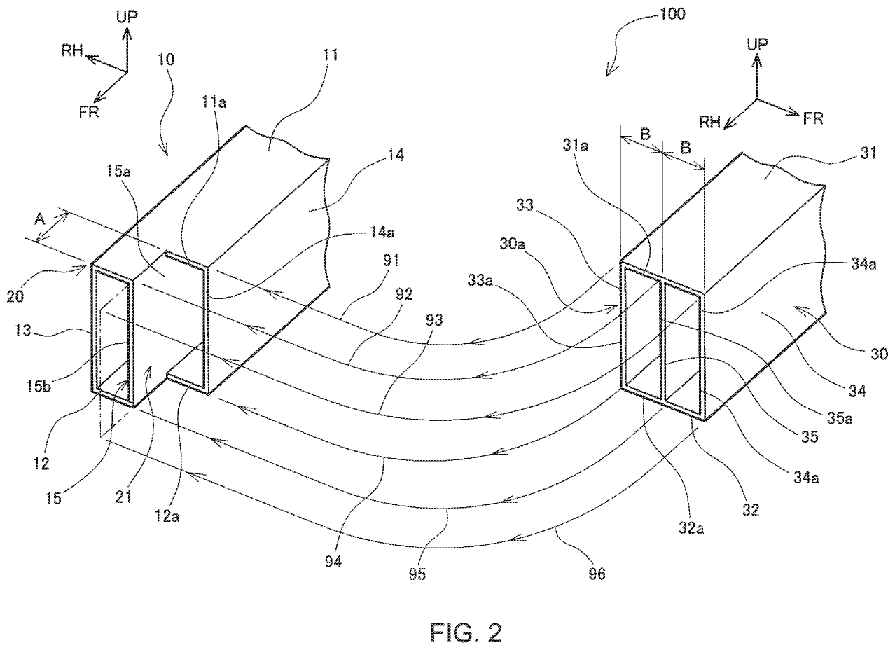

First, the first longitudinal member 10 and the second longitudinal member 30 before being combined will be described with reference to FIG. 2. As shown in FIG. 2, the first longitudinal member 10 extends in the front-rear direction of the member connecting structure 100, and the front end portion constitutes the first end portion 20. Accordingly, the longitudinal direction of the member connecting structure 100 is the longitudinal direction of the first longitudinal member 10. The left-right direction of the member connecting structure 100 is the width direction of the first longitudinal member 10. The vertical direction of the member connecting structure 100 is the vertical direction of the first longitudinal member 10. Similarly, the second longitudinal member 30 extends in the left-right direction of the member connecting structure 100, and the right end portion constitutes the second end portion 30a. Accordingly, the left-right direction of the member connecting structure 100 is the longitudinal direction of the second longitudinal member 30. The front-rear direction of the member connecting structure 100 is the width direction of the second longitudinal member 30. The vertical direction of the member connecting structure 100 is the vertical direction of the second longitudinal member 30.

The first longitudinal member 10 has a rectangular closed cross-sectional structure including an upper plate 11, a lower plate 12, a right side plate 13, a left side plate 14, and a first partition plate 15. The first partition plate 15 partitions the internal space of the first longitudinal member 10 into two spaces arranged in the width direction (left-right direction), and extends in the longitudinal direction of the first longitudinal member 10.

The first end portion 20 of the first longitudinal member 10 is provided with a notch portion 21. The notch portion 21 is a portion obtained by cutting out the left side of the distal end portion of the first end portion 20 by a length A in the front-rear direction. More specifically, the notch portion 21 is a portion obtained by cutting out the upper plate 11 and the lower plate 12 from the outer side surface of the left side plate 14 to the front side of the left side surface 15a of the first partition plate 15 in the width direction. The length of the notch portion 21 in the front-rear direction is a length A. The left side plate 14 of this portion is also cut out. The first partition plate 15 is not cut out. The outer side surface of the left side plate 14 constitutes a first outer side surface.

Since the upper plate 11, the lower plate 12, and the left side plate 14 are cut out as described above, the left side surface 15a of the first partition plate 15 is exposed in the notch portion 21. Further, by the notch, an left side front end surface 11a of the upper plate 11, a left side front end surface 12a of the lower plate 12, and a front end surface 14a of the left side plate 14 are formed rearward by a length A from the front end. The left side front end surface 11a, the left side front end surface 12a, and the front end surface 14a constitute a longitudinal end face of the notch portion 21. Thus, the notch portion 21 is a space defined by the left side surface 15a of the first partition plate 15, the left side front end surface 11a of the upper plate 11, the left side front end surface 12a of the lower plate 12, and the front end surface 14a of the left side plate 14. Here, the length A is the same as the length B in the width direction between the outer side surface of the rear side plate 33 of the second longitudinal member 30 and the center of the second partition plate 35, which will be described later.

Similar to the first longitudinal member 10, the second longitudinal member 30 has a rectangular closed cross-sectional structure including an upper plate 31, a lower plate 32, a rear side plate 33, a front side plate 34, and a second partition plate 35. The second partition plate 35 partitions the internal space of the second longitudinal member 30 into two spaces arranged in the width direction (front-rear direction), and extends in the longitudinal direction of the second longitudinal member 30. The second partition plate 35 is disposed at the center in the width direction of the second longitudinal member 30. The length B in the width direction between the outer surface of the rear side plate 33 and the center of the second partition plate 35 is equal to the length B in the width direction between the outer surface of the front side plate 34 and the center of the second partition plate 35. The second end portion 30a of the second longitudinal member 30 includes a right end surface 31a of the upper plate 31, a right end surface 32a of the lower plate 32, a right end surface 33a of the rear side plate 33, a right end surface 34a of the front side plate 34, and a right end surface 35a of the second partition plate 35. The right end surface 31a, 32a, 33a and 34a and the right end surface 35a of the second partition plate 35 constitute a distal end surface of the second longitudinal member. The outer side surface of the rear side plate 33 constitutes a second outer side surface.

Next, a combination of the first longitudinal member 10 and the second longitudinal member 30 will be described. As shown by arrows 91, 92, 94, and 95 shown in FIG. 2, the right end surface 33a of the rear side plate 33 of the second longitudinal member 30, the rear half of the right end surface 31a of the upper plate 31, the rear half of the right end surface 32a of the lower plate 32, and the right end surface 35a of the second partition plate 35 are brought into contact with the left side surface 15a of the first partition plate 15 of the notch portion 21. The outer side surface of the rear side plate 33 of the second longitudinal member 30 is brought into contact with the left side front end surface 11a of the upper plate 11, the left side front end surface 12a of the lower plate 12, and the front end surface 14a of the left side plate 14. As described above, since the length A of the notch portion 21 is equal to the length B in the width direction between the outer side surface of the rear side plate 33 of the second longitudinal member 30 and the center of the second partition plate 35, the right end surface 35a of the second partition plate 35 is brought into contact with the front end portion 15b of the first partition plate 15. Further, as shown by arrows 93 and 96 in FIG. 2, the front half of the second end portion 30a of the second longitudinal member 30 protrudes toward the front side of the notch portion 21.

In this way, the first longitudinal member 10 and the second longitudinal member 30 are combined so that the rear half portion, which is a part of the second end portion 30a of the second longitudinal member 30, abuts against the left side surface 15a of the first partition plate 15, and the outer side surface of the rear side plate 33 of the second longitudinal member 30 abuts against the longitudinal end surface of the notch portion 21. Then, a portion exposed on the outer surface of each of the contacted portions is welded and joined to form a member connecting structure 100 as shown in FIG. 1. Welding is performed, for example, between the rear half of the right end surface 31a of the upper plate 31 and the upper end of the left side surface 15a of the first partition plate 15, between the rear half of the right end surface 32a of the lower plate 32 and the lower end of the left side surface 15a of the first partition plate 15, between the front end surface 14a of the first longitudinal member 10 and the outer side surface of the rear side plate 33 of the second longitudinal member 30, between the left side front end surface 11a of the upper plate 11 of the first longitudinal member 10 and the outer side surface of the rear side plate 33 of the second longitudinal member 30, and between the left side front end surface 12a of the lower plate 12 of the first longitudinal member 10 and the outer side surface of the rear side plate 33 of the second longitudinal member 30. It may be performed between the front end portion 15b of the first partition plate 15 and the right end portion 35b of the second partition plate 35. The front end portion 15b of the first partition plate 15 and the right end portion 35b of the second partition plate 35 form a first plate end portion and a second plate end portion, respectively.

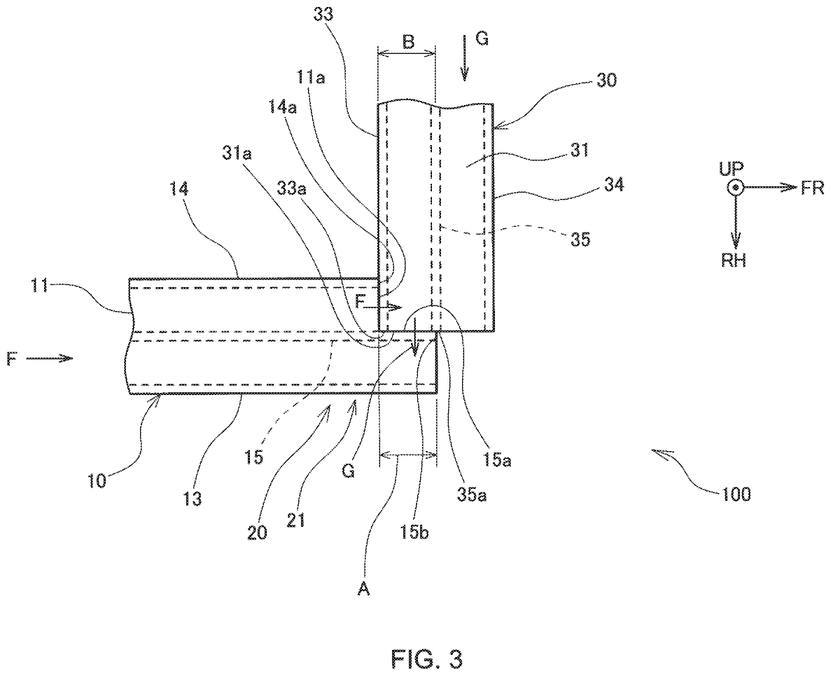

Next, transmission of the impact loads F and G when the impact loads F and G are applied to the member connecting structure 100 will be described with reference to FIG. 3. As shown in FIG. 3, when the impact load F is applied in the front-rear direction of the member connecting structure 100, the impact load F is transmitted from the left side front end surface 11a of the upper plate 11 of the first longitudinal member 10, the left side front end surface 12a of the lower plate 12, and the front end surface 14a of the left side plate 14 to the rear side plate 33 of the second longitudinal member 30. That is, the impact load F applied in the longitudinal direction of the first longitudinal member 10 is transmitted from the longitudinal end surface of the notch portion 21 of the first longitudinal member 10 to the outer side surface of the rear side plate 33 of the second longitudinal member 30. When the impact load G is applied in the left-right direction of the member connecting structure 100, the impact load G is transmitted to the left side surface 15a of the first partition plate of the first longitudinal member 10 from the rear half of the right end surface 31a of the upper plate 31 of the second longitudinal member 30, the rear half of the right end surface 32a of the lower plate 32, and the right end surface 35a of the second partition plate 35. That is, the impact load G applied in the longitudinal direction of the second longitudinal member is transmitted from a part of the distal end surface of the second longitudinal member 30 to the first partition plate 15 of the first longitudinal member 10. Thus, when the member connecting structure 100 receives the impact loads F and G from various directions, the member connecting structure 100 can reliably transmit the impact loads F and G through the notch portion 21.

Further, the member connecting structure 100 has a simple configuration in which the notch portion 21 is formed in the first longitudinal member 10, and the second end portion 30a of the second longitudinal member 30 which is not processed is brought into abutment with the notch portion 21 and welded. Therefore, cutting and welding of the bonded portion are facilitated, and bonding quality can be improved.

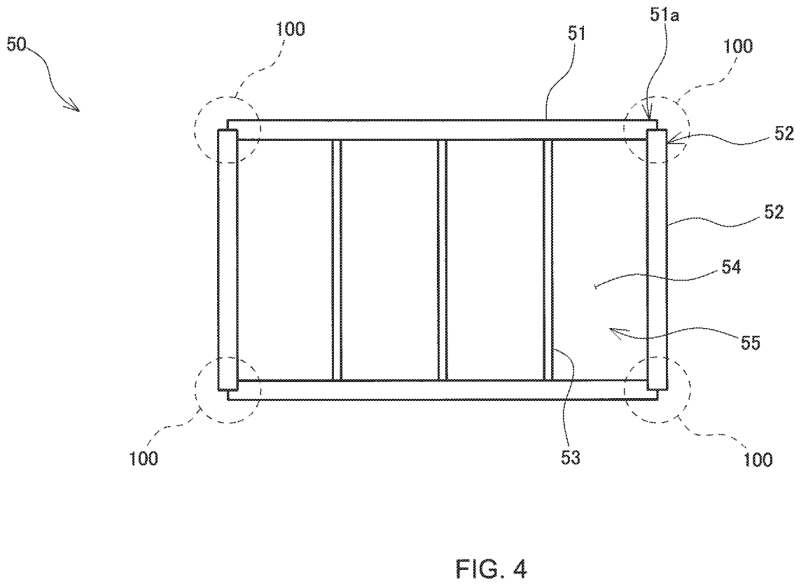

Next, a battery case 50 to which the member connecting structure 100 described with reference to FIGS. 1 to 3 is applied will be described with reference to FIG. 4. The battery case 50 includes two longitudinal frames 51, two width frames 52, a plurality of width ribs 53, and a flat plate 54. The longitudinal frame 51 and the width frame 52 are closed cross-sectional members. The end portions 52a of the width frames 52 are connected to the end portions 51a of the longitudinal frames 51 to form a rectangular frame-shaped outer frame. The width ribs 53 are closed cross-sectional members connecting the two longitudinal frames 51. The flat plate 54 is connected to each of the longitudinal frames 51, each of the width frames 52, and a lower side of each of the width ribs 53 to form a bottom surface. A battery is stored in each section 55 partitioned by each longitudinal frame 51, each width frame 52, or each width rib 53.

As shown in FIG. 4, the end portion 51a of the longitudinal frame 51 and the end portion 52a of the width frame 52 are connected by the member connecting structure 100 described above with reference to FIGS. 1 to 3. Therefore, the battery case 50 has a structure strong against impact loads F and G from various directions. Further, since cutting and welding of the joining portion are easy, the joining quality is improved, and penetration of water into the inside of the battery case 50 from the outside can be suppressed.

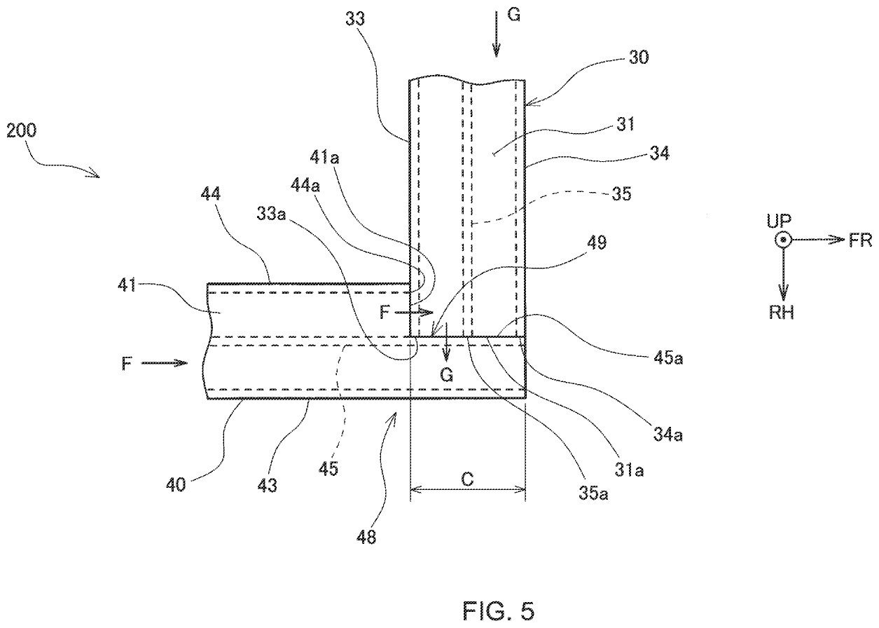

Next, a member connecting structure 200 according to another embodiment will be described with reference to FIG. 5. The same components as those of the member connecting structure 100 described above with reference to FIGS. 1 to 3 are denoted by the same reference numerals, and description thereof is omitted.

As shown in FIG. 5, in the member connecting structure 200 has a first longitudinal member 40 having a rectangular closed cross-sectional structure including an upper plate 41 having a left side front surface 41a, a right side plate 43, a left side plate 44 having a front end surface 44a, and a first partition plate 45 having a left side surface 45a. A notch portion 49 having a length C is provided in the first end portion 48 of the first longitudinal member 40. The length C of the notch portion 49 is the same as the length of the second longitudinal member 30 in the width direction. Therefore, when the second longitudinal member 30 is combined with the notch portion 49, the right end surface 33a of the rear side plate 33 of the second longitudinal member 30, the right end surface 31a of the upper plate 31, the right end surface 32a of the lower plate 32, the right end surface 35a of the second partition plate 35, and the right end surface 34a of the front side plate 34 abut on the left side surface 15a of the first partition plate 15. That is, the entire second end portion 30a of the second longitudinal member 30 abuts on the left side surface 15a of the first partition plate 15.

When the impact loads F and G are input to the member connecting structure 200, the impact loads F and G can be reliably transmitted through the notch portion 49 as in the case of the member connecting structure 100 described with reference to FIG. 3.

1. A member connecting structure for connecting a first end portion of a first longitudinal member and a second end portion of a second longitudinal member at an angle; wherein
the first longitudinal member has a closed cross section and includes a first partition plate partitioning an inner space in a width direction,
the first end portion includes a notch portion in which a distal end portion is cut out in a width direction from a first outer side surface up to the first partition plate,
the second end portion is combined with the notch portion such that a distal end surface of the second end portion abuts against the first partition plate of the notch portion and a second outer side surface of the second end portion abuts against a longitudinal end surface of the first longitudinal member at the notch portion, and the second end portion is welded to the first end portion.

2. The member connecting structure according to claim 1, wherein
the second longitudinal member has a closed cross section and includes a second partition plate partitioning an inner space in a width direction,
the length of the notch portion in a longitudinal direction of the first longitudinal member is the same as the length in the width direction between the second outer side surface and the second partition plate of the second longitudinal member,
the second end portion is combined with the notch portion such that a part of the distal end surface abuts against the first partition plate of the notch portion, and is welded to the first end portion.

3. The member connecting structure according to claim 2,
a first plate end portion of the first partition plate is welded to a second plate end portion of the second partition plate.

4. A battery case in which two first longitudinal members and two second longitudinal members are connected in a rectangular frame shape;
each of the first longitudinal members and each of the second longitudinal members are connected by the member connecting structure according to claim 1.

5. A battery case in which two first longitudinal members and two second longitudinal members are connected in a rectangular frame shape;
each of the first longitudinal members and each of the second longitudinal members are connected by the member connecting structure according to claim 2.

6. A battery case in which two first longitudinal members and two second longitudinal members are connected in a rectangular frame shape;
each of the first longitudinal members and each of the second longitudinal members are connected by the member connecting structure according to claim 3.
